(19) United States
(12) Patent Application Publication
(10) Pub. No.: US 2006/0227684 A1
(43) Pub. Date: Oct. 12, 2006

(54) Adjusting of recording speed of optical drive based on under-run

(75) Inventors: Yung-Chih Hsu, Taoyuan (TW); Ya-Ping Pan, Taoyuan (TW); Yu-Cheng Sung, Taoyuan (TW)

Correspondence Address: Richard P. Berg, Esq.;c/o LADAS & PARRY, 5670 Wilshire Boulevard, Suite 2100, Los Angeles, CA, 90036-5679, US

(73) Assignee: BENO Corporation

(21) Appl. No.: 11/400,137

(22) Filed: Apr. 7, 2006

(30) Foreign Application Priority Data
Apr. 8, 2005 (TW) 094111124

(51) Int. Cl. G11B 19/00

(52) U.S. Cl. 369/47.41

(57) ABSTRACT

The invention is to provide a method for controlling the recording speed of an optical drive. The optical drive includes a buffer for storing data transferred from an external source, and the optical drive continuously records the data onto an optical disc. According to a preferred embodiment of the method of the invention, first, the recording speed of the optical drive is set to equal to the k-th allowable recording speed in the N allowable recording speeds. When the optical drive performs continuous recording for M times, a first data transfer rate between the external source and the buffer is calculated according to an algorithm, and a second data transfer rate is calculated according to the l-th allowable recording speed, where I is an integer smaller than k. If the first data transfer rate is slower than the second data transfer rate, the recording speed of the optical drive is lowered.

### BACKGROUND OF THE INVENTION

1. Field of the Invention

The present invention relates to a method for controlling the recording speed of an optical drive.

2. Description of the Prior Art

When using an optical drive to record data onto an optical disc, users usually choose the highest speed that the optical drive can support to record data. However, using the highest speed does not mean spending the least time to record data onto the optical disc.

When the optical drive records data onto the optical disc at a rapid speed, the condition of buffer under-run will happen if the transfer rate of the computer cannot support the speed to transfer data to a buffer of the optical drive. Once the condition of buffer under-run happens, the optical drive has to stop the action of recording data until the data stored in the buffer reach a threshold amount and starts to record data again. Therefore, when the speed of the computer cannot support the recording speed of the optical drive, the condition of buffer under-run will happen repeatedly and will cause the total recording time of recording data onto the disc to be even longer than that of using slower speed to record. This kind of condition not only sacrifices the recording quality of the optical drive, but also wastes more time to complete the action of recording data.

Accordingly, a scope of the invention is to provide a method for controlling the recording speed of an optical drive that solves the problem mentioned above, so as to reach the objective of optimizing the overall recording time.

### SUMMARY OF THE INVENTION

A scope of the invention is to provide a method for controlling the recording speed of an optical drive. The optical drive is capable of operating at one of the N allowable recording speeds among which the first allowable recording speed to the Nth allowable recording speed are sorted from slow to rapid, and N is an integer larger than 1. The optical drive includes a buffer for storing data transferred from an external source, and the optical drive continuously records the data stored in the buffer onto an optical disc.

In the method, first, the recording speed of the optical drive is set to equal the k-th allowable recording speed in the N allowable recording speeds, and k is an integer index ranging from 1 to N. Next, a judgment step is performed to judge if the k-th allowable recording speed is the slowest possible speed among the N allowable recording speeds. If the k-th allowable recording speed is the slowest one among the N allowable recording speeds, the current recording speed of the optical drive is kept.

If the k-th allowable recording speed is not the slowest one among the N allowable recording speeds, the following steps are performed. When the optical drive performs continuous recording for M times, a first data transfer rate between the external source and the buffer is calculated according to an algorithm, and a second data transfer rate is calculated according to the l-th allowable recording speed in the N allowable recording speeds, where l is an integer smaller than k. After calculating the first data transfer rate and the second data transfer rate, a judging step is performed to judge if the first data transfer rate is slower than the second data transfer rate. If the first data transfer rate is slower than the second data transfer rate, the recording speed of the optical drive is adjusted to the (k-1)th allowable recording speed in the N allowable recording speeds.

The method for controlling the recording speed of an optical drive employs the amount of the transferred data of the buffer and the transferring time to calculate the transfer rate between the computer and the optical drive. When the transfer rate of the computer is inadequate, the speed of the optical drive can be adjusted; hence, users can use the adaptive speed to record data onto the optical disc to reduce the total recording time.

The advantage and spirit of the invention may be understood by the following recitations together with the appended drawings.

### BRIEF DESCRIPTION OF THE APPENDED DRAWINGS

FIG. 1 is a flowchart illustrating the procedure of the method of the invention for controlling the recording speed of an optical drive.

FIG. 2 is a flowchart illustrating the procedure of the method for controlling the recording speed of an optical drive according to a preferred embodiment of the invention.

FIG. 3 is a block diagram illustrating a preferred embodiment of a device according to the method of the invention for controlling a recording speed of an optical drive.

### DETAILED DESCRIPTION OF THE INVENTION

An objective of the invention is to provide a method for controlling the recording speed of an optical drive, and the purpose of the method is to shorten the overall recording time to the shortest possible time.

The optical drive is capable of operating at one of N allowable recording speeds among which the first allowable recording speed to the Nth allowable recording speed are sorted from slow to rapid, and N is an integer larger than 1. The optical drive includes a buffer for storing data transferred from an external source, and the optical drive continuously records the data stored in the buffer onto an optical disc.

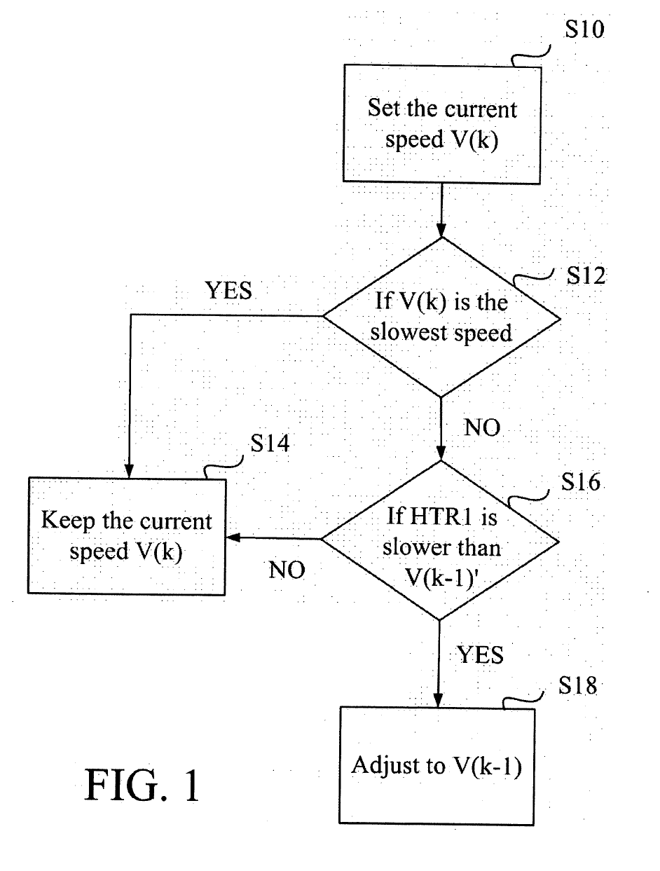

Referring to FIG. 1, FIG. 1 is a flowchart illustrating the procedure of the method of the invention for controlling the recording speed of an optical drive. First, step S10 is performed to set the recording speed of the optical drive to the k-th allowable recording speed, shown in FIG. 1 as V(k), in the N allowable recording speeds, and k is an integer index ranging from 1 to N. Next, step S12 is performed to judge if the k-th allowable recording speed is the slowest one among the N allowable recording speeds. If the k-th allowable recording speed is the slowest one among the N allowable recording speeds, step S14 is performed. In step S14, the current recording speed of the optical drive is kept.

If the k-th allowable recording speed is not the slowest one among the N allowable recording speeds, the following steps are performed. When the optical drive performs continuous recording for M times, a first data transfer rate between the external source and the buffer is calculated according to an algorithm, and a second data transfer rate, shown in FIG. 1 as V(k-1)′, is calculated according to the l-th allowable recording speed, shown in FIG. 1 as V(k-1), in the N allowable recording speeds where I is an integer smaller than k. After calculating the first data transfer rate and the second data transfer rate, step S16 is performed to judge if the first data transfer rate is slower than the second data transfer rate. If the first data transfer rate is slower than the second data transfer rate, step S18 is performed to adjust the recording speed of the optical drive to the (k-1)th allowable recording speed in the N allowable recording speeds. If the first data transfer rate is faster than the second data transfer rate, step S14 is performed to keep the recording speed of the optical drive as the k-th allowable recording speed.

In an embodiment, the data is transferred in the form of blocks from the external source, and the algorithm is as follows:

$$HTR 1 = [ {\sum }_{i = 1}^{M} {RS}_{i} ⨯ \frac{{X}_{i} - WTB}{{X}_{i}} ] / M$$

wherein HTR1 represents the first data transfer rate; i represents the i-th continuous recording among the M times of continuous recording, and each continuous recording is between two buffer under-runs. Xᵢ represents the total amount of the block at the i-th continuous recording, and RSᵢ represents a current recording speed of the optical drive at the i-th continuous recording; furthermore, WTB (Writing threshold blocks) represents a threshold amount of blocks that have been stored in the buffer at the start of the i-th continuous recording. In other words, when the amount of blocks reaches the WTB, the optical drive starts the action of recording data.

In an embodiment, the optical drive includes a spindle motor for driving the rotation of the optical disc. When the spindle motor is controlled in a constant angular velocity (CAV) mode, RSᵢ is calculated by the following formula:

$${RS}_{i} = \frac{{Vstart}_{i} + {Vstop}_{i}}{2}$$

wherein Vstartᵢ represents a speed of the spindle motor at the start of the i-th continuous recording, and Vstopᵢ represents the speed of the spindle motor at the end of the i-th continuous recording.

When the spindle motor is controlled in a CLV (Constant linear velocity) mode or a Z-CLV (Zoned constant linear velocity) mode, RSᵢ is the speed of the spindle motor at the i-th continuous recording.

In an embodiment, the second data transfer rate is calculated in accordance with the (k-1)th allowable recording speed in the N allowable recording speeds. The second data transfer rate is calculated by multiplying the (k-1)th allowable recording speed by a first multiple which is equal to or larger than 1, such as 1.1.

In another embodiment, the data is transferred in the form of blocks from the external source. The optical disc complies with a specification, and the algorithm is as follows:

$$HTR 1 = [ {\sum }_{i = 1}^{M} \frac{{X}_{i}}{{T}_{i}} ⨯ \frac{1}{1 X\_TransferRate} ] / M$$

wherein HTR1 represents the first data transfer rate, and i represents the i-th continuous recording among the M times of continuous data recording; each continuous recording is between two buffer under-runs. Xᵢ represents an total amount of the block at the i-th continuous recording, T₁ represents a duration for transferring Xᵢ, and 1X_TransferRate represents a data transfer rate unit specified in the specification. The first data transfer rate is calculated by the algorithm.

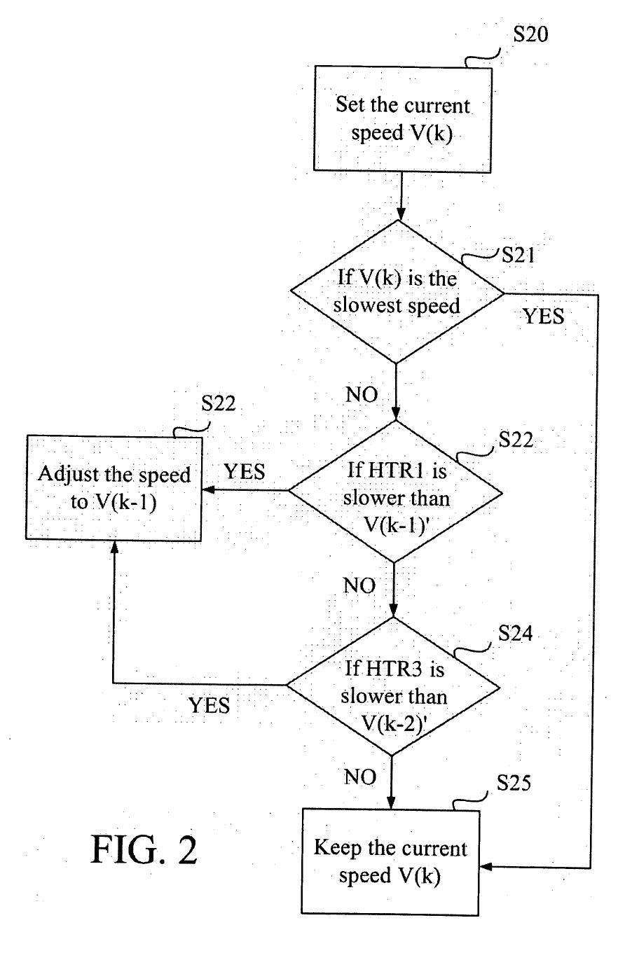

Referring to FIG. 2, FIG. 2 is a flowchart illustrating the procedure of the method for controlling a recording speed of an optical drive according to a preferred embodiment of the invention.

In this preferred embodiment, the optical drive is capable of operating at one of N allowable recording speeds among which the first allowable recording speed to the Nth allowable recording speed are sorted from slow to rapid, and N is an integer larger than 1. For example, a 16x optical drive is capable of operating at 2x, 4x, 8x, 12x, and 16x recording speeds. The optical drive includes a buffer for storing data transferred, in the form of blocks, from an external source such as a computer, and the optical drive continuously records the data stored in the buffer onto an optical disc.

As shown in FIG. 2, the procedure of the method for controlling the recording speed of an optical drive according to a preferred embodiment of the invention is, first, to perform step S20 to set the recording speed of the optical drive to equal to the k-th allowable recording speed, shown in FIG. 2 as V(k), in the N allowable recording speeds, and k is an integer index ranging from 1 to N. Next, step S21 is performed to judge if the k-th allowable recording speed is the slowest one among the N allowable recording speeds. If the k-th allowable recording speed is not the slowest one among the N allowable recording speeds, the following steps are performed.

When the optical drive performs continuous recording for M times, a first data transfer rate between the external source and the buffer is calculated according to a first algorithm, and M is a natural number. The algorithm is as follows:

$$HTR 1 = [ {\sum }_{i = 1}^{M} {RS}_{i} ⨯ \frac{{X}_{i} - WTB}{{X}_{i}} ] / M$$

wherein HTR1 represents the first data transfer rate, i represents the i-th continuous recording among M times of continuous data recording, and each continuous recording is between two buffer under-runs. Xᵢ represents the total amount of the block at the i-th continuous recording, RSᵢ represents a current recording speed of the optical drive at the i-th continuous recording, and WTB (Writing threshold blocks) represents a threshold amount of blocks that have already been stored in the buffer at the start of the i-th continuous recording. In other words, when the amount of blocks reaches the WTB, the optical drive starts the action for recording data.

A second data transfer rate, shown in FIG. 2 as V(k-1)′, is calculated according to the (k-1)th allowable recording speed, shown in FIG. 2 as V(k-1), in the N allowable recording speeds. The second data transfer rate is calculated by multiplying the (k-1)th allowable recording speed by a first factor equal to or larger than 1, such as 1.1.

After calculating the first data transfer rate and the second data transfer rate, step S22 is performed to judge if the first data transfer rate is slower than the second data transfer rate. If the first data transfer rate is less than the second data transfer rate, step S23 is performed to adjust the recording speed of the optical drive to equal to the (k-1)th allowable recording speed in the N allowable recording speeds. If the first data transfer rate is faster than the second data transfer rate, the following procedure is performed.

A third data transfer rate between the external source and the buffer is calculated according to a second algorithm. The optical disc complies with a specification, and the second algorithm is as follows:

$$HTR 3 = [ {\sum }_{i = 1}^{M} \frac{{X}_{i}}{{T}_{i}} ⨯ \frac{1}{1 X\_TransferRate} ] / M$$

wherein HTR3 represents the third data transfer rate, Tᵢ represents a duration for transferring Xᵢ, and 1X_TransferRate represents a data transfer rate unit specified in the specification. For example, the 1X_TransferRate of DVD disc is 1385 kilobit per second, and the 1X_TransferRate of CD disc is 150 kilobit per second. A fourth data transfer rate, shown in FIG. 2 as V(k-2)′, is calculated according to the (k-2)th allowable recording speed, shown in FIG. 2 as V(k-2), in the N allowable recording speeds. The fourth data transfer rate is calculated by multiplying the (k-2)th allowable recording speed by a second factor equal to or larger than 1, such as 1.1.

After calculating the third data transfer rate and the fourth data transfer rate, step S24 is performed to judge if the third data transfer rate is slower than the fourth data transfer rate. If the third data transfer rate is less than the fourth data transfer rate, step S23 is performed to adjust the recording speed of the optical drive to equal to the (k-1)th allowable recording speed in the N allowable recording speeds. If the third data transfer rate is faster than the fourth data transfer rate, step S25 is performed to keep the recording speed of the optical drive to equal to the k-th allowable recording speed in the N allowable recording speeds.

The data transfer rate calculated by the first algorithm is mostly decided by the speed of the software, and the operation time of the server is not put into consideration. Therefore, the calculated first data transfer rate is faster than the actual data transfer rate. The third data transfer rate calculated by the second algorithm is used for confirming if the current recording speed of the optical drive is appropriate. The operation time of the server is considered in the second algorithm; consequently, the calculated third data transfer rate is much slower than the first data transfer rate. The second algorithm can be used to distinguish if there is a significant difference between the recording speed of the optical drive and the data transfer rate between the external source and the buffer.

In an embodiment, the optical disc is a DVD+R disc.

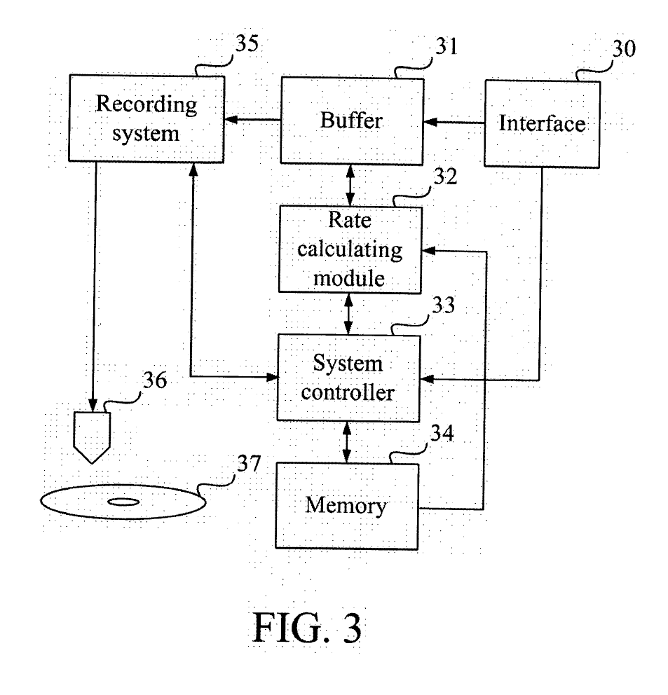

Referring to FIG. 3, FIG. 3 is a block diagram illustrating a preferred embodiment of a device according to the method of the invention for controlling a recording speed of an optical drive. As shown in FIG. 3, an optical drive, such as a DVD+R drive is coupled to a host or a standalone. The optical drive includes an interface 30, a buffer 31, a recording system 35, and an optical pick-up unit 36. The interface 30 is coupled to the host. The buffer 31 is used for storing the input data, such as external data, received via the interface 30. The recording system 35 employs the optical pick-up 36 to record the data transferred from the buffer 31 onto an optical disc 37. The optical drive further includes a system controller 33, a memory 34, and a rate calculating module 32. The system controller 33 controls the recording system 35 in accordance with a recording rate requested by a user from the host via the interface 30, and the system controller 33 also changes or reduces the data recording speed of the recording system 35, according to the data transferred from the rate calculating module 32, to an optimal recording speed. The memory 34 stores a plurality of recording speed data. The rate calculating module 32 checks the total amount of blocks at each continuous recording and the duration of each buffer 31 under-run and gets the recording speed data from the memory 34 to determine if the current recording speed is appropriate.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for controlling a recording speed of an optical drive capable of operating at one of N allowable recording speeds among which the first allowable recording speed to the Nth allowable recording speed are sorted from slow to rapid, N being an integer larger than 1, said optical drive comprising a buffer for storing data transferred from an external source, said optical drive continuously recording the data stored in the buffer onto an optical disc, said method comprising the steps of:
(a) setting the recording speed of the optical drive equal to the k-th allowable recording speed in the N allowable recording speeds, k being an integer index ranging from 1 to N;
(b) when the optical drive performs continuous recording for M times, calculating a first data transfer rate between the external source and the buffer in accordance with a first algorithm, M being a natural number;
(c) according to the l-th allowable recording speed, calculating a second data transfer rate, l being an integer smaller than k;
(d) judging if the first data transfer rate is slower than the second data transfer rate; and
(e) if YES in step (d), lowering the recording speed of the optical drive.

2. The method of claim 1, between step (a) and step (b), further comprising the steps of:
(b1) judging if the k-th allowable recording speed is the slowest one among the N allowable recording speeds; and
(b2) if NO in step (b1), performing steps (b) through (e).

3. The method of claim 1, wherein l is equal to (k-1).

4. The method of claim 1, wherein in step (e), the lowering of the recording sped of the optical drive is performed by adjusting the recording speed of the optical drive equal to the (k-1)th allowable recording speed.

5. The method of claim 1, wherein the data is transferred in the form of blocks from the external source, the first algorithm is as follows:
$$HTR 1 = [ {\sum }_{i = 1}^{M} {RS}_{i} ⨯ \frac{{X}_{i} - WTB}{{X}_{i}} ] / M$$
wherein HTR1 represents the first data transfer rate, i represents the i-th continuous recording among the M times of continuous recording, Xᵢ represents the total amount of blocks at the i-th continuous recording, RSᵢ represents a current recording speed of the optical drive at the i-th continuous recording, and WTB (Writing threshold blocks) represents a threshold amount of blocks that have been stored in the buffer at the start of the i-th continuous recording.

6. The method of claim 5, wherein the optical disc comprises a spindle motor for driving the rotation of the optical disc; the spindle motor is controlled in a constant angular velocity (CAV) mode, and RSᵢ is calculated by the following formula:
$${RS}_{i} = \frac{{Vstart}_{i} + {Vstop}_{i}}{2}$$
wherein Vstartᵢ represents a speed of the spindle motor at the start of the i-th continuous recording, and Vstopᵢ represents the speed of the spindle motor at the end of the i-th continuous recording.

7. The method of claim 5, wherein the optical disc comprises a spindle motor for driving the rotation of the optical disc; the spindle motor is controlled in a CLV (Constant linear velocity) mode or a Z-CLV (Zoned constant linear velocity) mode, and RSᵢ is equal to the speed of the spindle motor at the i-th continuous recording.

8. The method of claim 5, if NO in step (d), further comprising the steps of:
(f) calculating a third data transfer rate between the external source and the buffer in accordance with a second algorithm;
(g) according to the (k-2)th allowable recording speed, calculating a fourth data transfer rate;
(h) judging if the third data transfer rate is slower than the fourth data transfer rate; and
(i) if YES in step (h), adjusting the recording speed of the optical drive equal to the (k-1)th allowable recording speed.

9. The method of claim 8, wherein the optical disc complies with a specification, the second algorithm is as follows:
$$HTR 3 = [ {\sum }_{i = 1}^{M} \frac{{X}_{i}}{{T}_{i}} ⨯ \frac{1}{1 X\_TransferRate} ] / M$$
wherein HTR3 represents the third data transfer rate, Tᵢ represents a duration for transferring Xᵢ, and 1X_TransferRate represents a data transfer rate unit specified in the specification.

10. The method of claim 8, wherein the second data transfer rate is calculated by multiplying the (k-1)th allowable recording speed by a first factor equal to or larger than 1, and the fourth data transfer rate is calculated by multiplying the (k-2)th allowable recording speed by a second factor equal to or larger than 1.

11. The method of claim 1, wherein the data is transferred in the form of blocks from the external source, the optical disc complies with a specification, the first algorithm is as follows:
$$HTR 1 = [ {\sum }_{i = 1}^{M} \frac{{X}_{i}}{{T}_{i}} ⨯ \frac{1}{1 X\_TransferRate} ] / M$$
wherein HTR1 represents the first data transfer rate, i represents the i-th continuous recording among the M times of continuous recording, Xᵢ represents the total amount of blocks at the i-th continuous recording, Tᵢ represents a duration for transferring Xᵢ, and 1X_TransferRate represents a data transfer rate unit specified in the specification.

12. The method of claim 11, wherein the second data transfer rate is calculated by multiplying the (k-1)th allowable recording speed by a factor equal to or larger than 1.

13. The method of claim 1, wherein the optical disc is a DVD+R disc.
